(19) United States
(12) Patent Application Publication
(10) Pub. No.: US 2015/0278131 A1
(43) Pub. Date: Oct. 1, 2015

(54) DIRECT MEMORY ACCESS CONTROLLER WITH GENERAL PURPOSE INPUTS AND OUTPUTS

(71) Applicant: KAY HESSE, Dresden (DE)

(72) Inventor: KAY HESSE, Dresden (DE)

(21) Appl. No.: 14/225,928

(22) Filed: Mar. 26, 2014

(51) Int. Cl. G06F 13/28; G06F 13/16

(52) U.S. Cl. CPC G06F 13/28; G06F 13/16

(57) ABSTRACT

A DMA controller with general programmability and functionality is described. The DMA controller includes a bus interface coupled to an internal memory domain and an external memory domain and general purpose input and output lines. The DMA controller also includes a set of instruction registers that can store (and a processing unit to execute) instructions to transfer data using the bus interface and to read or write signals on the general purpose lines.

### TECHNICAL FIELD

Embodiments described herein generally relate to processing devices and, more specifically, relate to direct memory access controllers.

### BACKGROUND

Processing devices access memory when performing operations and/or when executing instructions of an application. For example, a processing device may read data from a memory location and/or may write data to a memory location when adding two numbers (e.g., may read the two numbers from multiple memory locations and may write the result to another memory location). Data may be moved from one memory location to another memory location by a central processing unit (CPU) or by a specialized hardware device, a direct memory access (DMA) controller.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 is a block diagram of a system architecture, according to one embodiment of the disclosure.

FIG. 2 is a block diagram of a direct memory access (DMA) controller, according to an embodiment of the disclosure.

FIG. 3 is a flow diagram illustrating a method of executing instructions, according to one embodiment of the disclosure.

FIG. 4 is a block diagram of a layout of a generic descriptor, according to one embodiment of the disclosure.

FIG. 5 is a block diagram of a group of descriptors, according to one embodiment of the disclosure.

FIG. 6 is a flow diagram illustrating a method of switching off and switching on an internal memory domain, according to one embodiment of the disclosure.

FIG. 7 is a block diagram of a system on chip (SoC), in accordance with an embodiment of the present disclosure.

FIG. 8 is a block diagram of an embodiment of a system on-chip (SoC) design, in accordance with another embodiment of the present disclosure.

FIG. 9 is a block diagram of a computer system, according to one embodiment of the present disclosure.

FIG. 10A is a block diagram illustrating an in-order pipeline and a register renaming stage, out-of-order issue/execution pipeline implemented by a processor core, in accordance with one embodiment of the present disclosure.

FIG. 10B is a block diagram illustrating an in-order architecture core and a register renaming logic, out-of-order issue/execution logic to be included in a processor according to at least one embodiment of the disclosure.

FIG. 11 is a block diagram of the micro-architecture for a processor that includes logic circuits to perform instructions, in accordance with one embodiment of the present invention.

FIG. 12 illustrates a diagrammatic representation of a machine in the example form of a computer system within which a set of instructions, for causing the machine to perform any one or more of the methodologies discussed herein, may be executed.

### DESCRIPTION OF EMBODIMENTS

Processing devices access memory when performing operations and/or when executing instructions of an application. For example, a processing device may read data from a memory location and/or may write data to a memory location when adding two numbers (e.g., may read the two numbers from multiple memory locations and may write the result to another memory location). Data may be moved from one memory location to another memory location by a central processing unit (CPU) or by a specialized hardware device, a direct memory access (DMA) controller.

The DMA controller may advantageously transfer data between two memory locations, relieving the CPU of this task. However, typical DMA controllers are limited in their functionality to transferring data between memory locations. Described herein are DMA controllers with general purpose input and output lines (in addition to a bus interface) and with extended functionality to take advantage of these additional lines. In particular, the DMA controller may perform operations associated with descriptors that describe memory-to-memory transfers and further performs operations described by descriptors that allow reading and writing on general purpose inputs and outputs which are separate from the inputs and outputs used for such memory-to-memory transfer, descriptors that allow reading and writing of general purpose data registers which are separate from the memories of such memory-to-memory transfer, and branch descriptors that are used to define operation flow. The functionality provided by the additional descriptors allows for flexible interaction with other blocks of a system-on-chip (SoC) architecture (e.g., a power controller unit or processor cores).

In one embodiment, a DMA controller is coupled to a power controller, and the DMA controller is used to save/restore memory blocks to an external RAM (random access memory) before/after a power controller unit switches off internal RAM to avoid power leakage. This save/restore can be performed without software interaction to further relieve the CPU of tasks. Further, the save/restore can be performed more efficiently (with the internal RAM switched off as soon as possible and switched on as late as possible), thereby reducing power used by the system. Additional power can be saved by allowing the power controller to switch off the DMA controller itself or allowing the power controller to switch off all of the internal memory domains of the system, leaving none switched on.

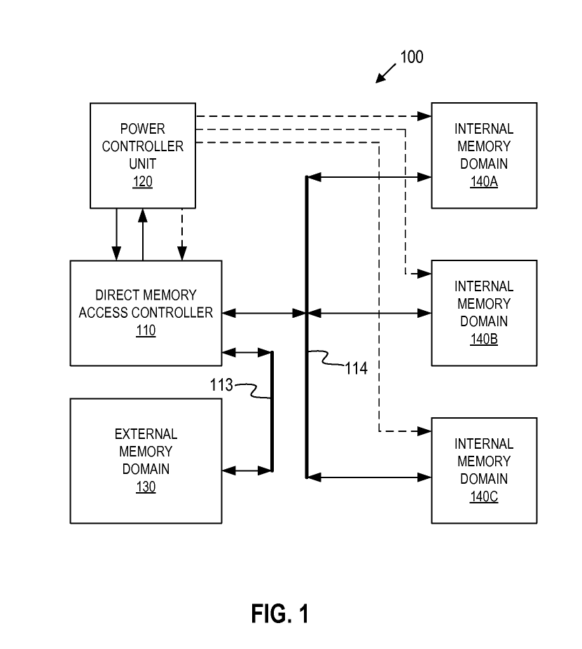

FIG. 1 is a block diagram of a computer system 100, according to one embodiment of the disclosure. The computer system 100 includes a direct memory access (DMA) controller 110 coupled to a power controller unit 120 by a general purpose input and a general purpose output. Although illustrated as a single arrow in each direction in FIG. 1, it is to be appreciated that the general purpose input and general purpose output may each include a plurality of connections allowing multiple bits to be exchanged between the DMA controller 110 and the power controller unit 120 at any one time.

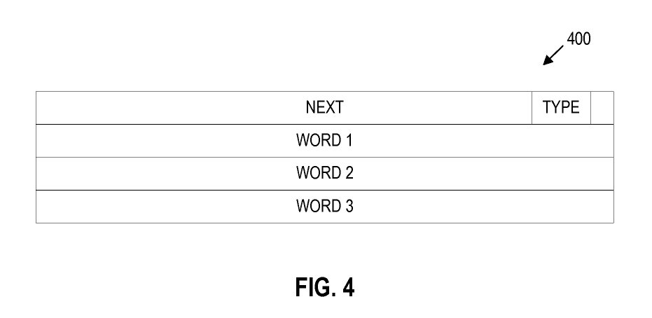

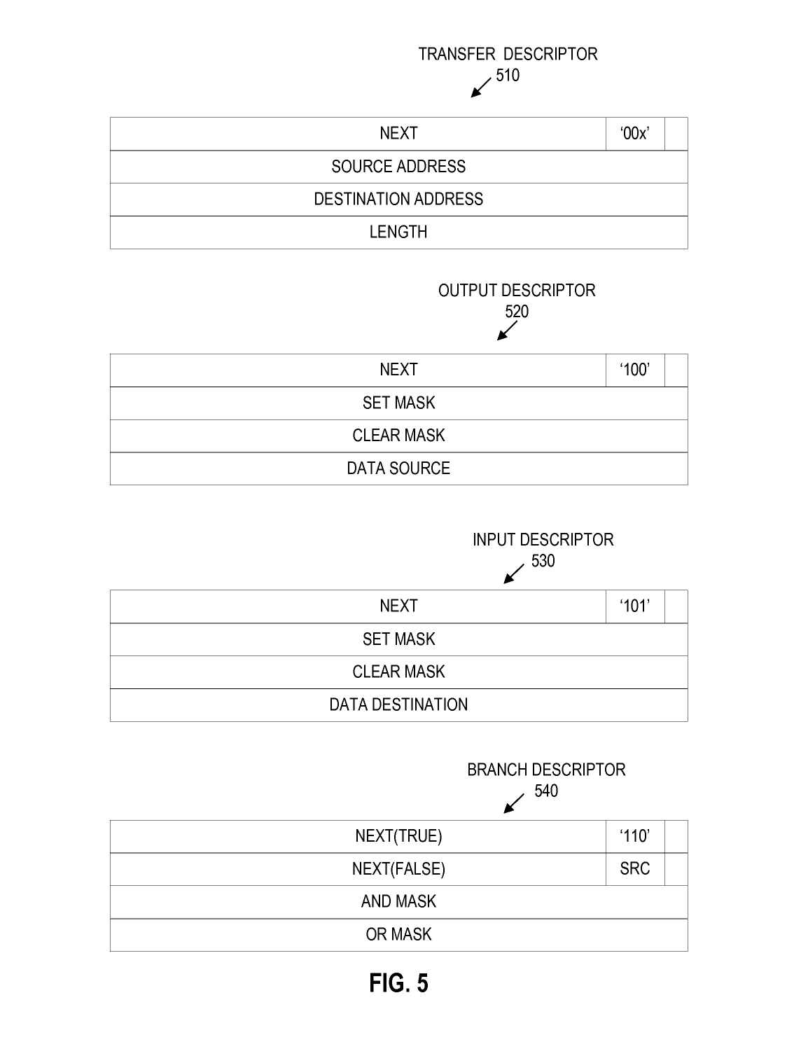

The DMA controller 110 is further coupled by an external bus 113 to an external memory domain 130 and by an internal bus 114 to a plurality of internal memory domains 140A-140C. Note that three internal memory domains 140A-140C are shown for illustration, but that more or fewer internal memory domains may be used. The DMA controller 110 may read data from and write data to the external memory domain 130 via the external bus 113. The DMA controller 110 may read instructions from the external memory domain 130 and execute the instructions. In particular, the instructions may include a descriptor chain of one or more descriptors, each of the descriptors describing an operation to be performed by the DMA controller 110 and, thus, being a set of instructions for the DMA controller 110. An example format for a generic descriptor is illustrated in FIG. 4 and described further below. Example formats for a few specific descriptors are illustrated in FIG. 5 and also described further below.

The DMA controller 110 may read data from and write data to the internal memory domains 140A-140C via the internal bus 114. Each of the internal memory domains 140A-140C includes a memory and may include a corresponding processor. The memory may store data and instructions for the corresponding processor. The memory may include one memory that stores both data and instructions or may include separate memories for data and instructions. In one embodiment, the memory is volatile. In particular, the memory may be random access memory (RAM). The memory may include a number of memory locations each specified by a memory address.

The external memory domain 130 similarly includes a memory which may be volatile (e.g., RAM) or non-volatile (e.g. magnetic disk drive) and includes a number of memory locations specified by memory addresses. The external memory domain 130 may correspond to always-on memory.

The DMA controller 110 may read a descriptor from the external memory 130 instructing the DMA controller 110 to read data from a specific memory address of one of the internal memory domains 140A and write the data to a specific memory address of the external memory domain 130. The descriptor may instruct the DMA controller 110 to copy all of the data from one of the internal memory domains 140A to the external memory domain 130. A following descriptor may instruct the DMA controller 110 to output a signal to the power controller unit 120 on a general purpose output line, the signal indicating to the power controller unit 120 that all the data has been backed up in the external memory domain 130 and that it is safe (e.g., without losing data) to switch off the internal memory domain 140A.

The power controller unit 120 is coupled to each of the internal memory domains 140A-140C (as indicated by the dashed lines in FIG. 1) and can separately switch off or switch on each of the internal memory domains 140A-140C by withdrawing or providing power to the domain. The power controller unit 120 is also coupled to the DMA controller 110 and can switch off or switch on the DMA controller 110. Switching off a domain may include powering down the domain, putting the domain into sleep mode, or completely cutting power to the domain. Likewise, switching on a domain may include powering up the domain, waking up the domain, or returning power to the domain.

In one embodiment, the DMA controller 110 is further coupled to the internal memory domains 140A-140C by one or more general purpose inputs and outputs. Thus, the DMA controller 110 can issue interrupts or other non-data signals to the internal memory domains 140A-140C. For example, after a successful restore operation in which the DMA controller 110 copies data from the external memory domain 130 to one of the internal memory domains 140A, it may further send a signal on a general purpose output to the internal memory domain 140A triggering the internal memory domain to begin executing instructions copied into the instruction memory of the internal memory domain 140A.

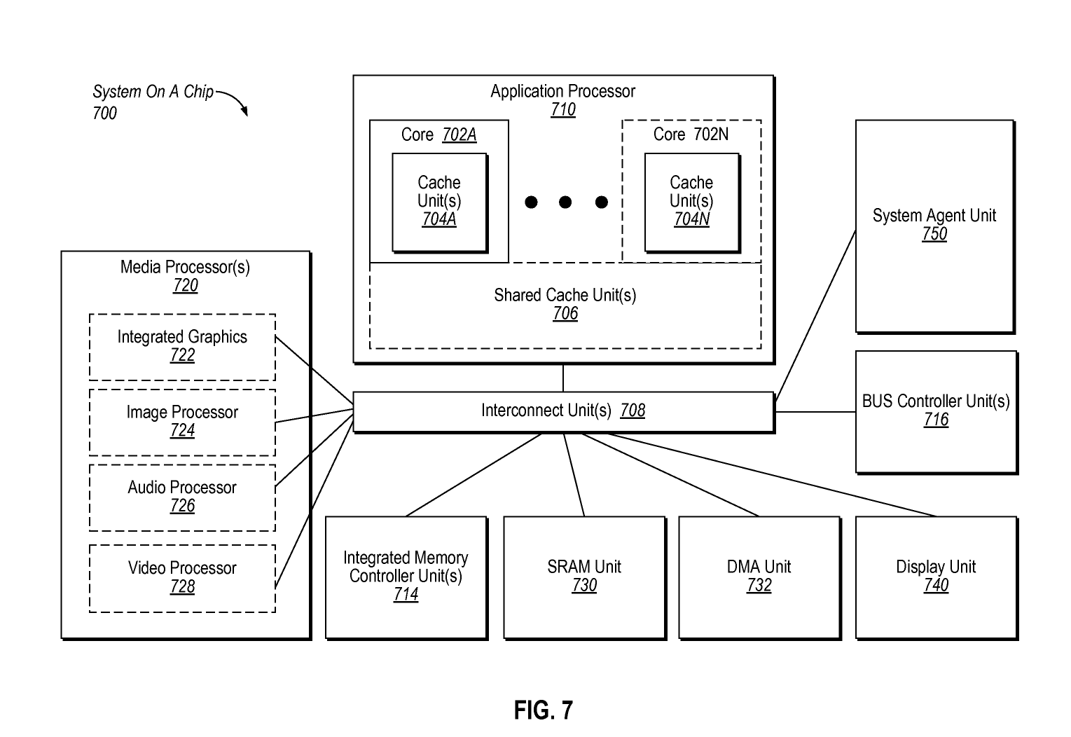

The computer system 100 may include other components (e.g., as described below with respect to FIGS. 7-12) and the DMA controller 110, power controller unit 120, external memory domain 130 and internal memory domains 140A may be coupled to one or more of these other components.

Further, the DMA controller 110 is illustrated in FIG. 1 as coupled to a power controller unit 120 by its general purpose inputs and outputs and is generally described below as operating in conjunction with the power controller unit 120 to switch on and off domains to save power. However, in other implementations the DMA controller 110 may be coupled to other components for other purposes. For example, the DMA controller 110 may be coupled to a processor to intelligently load data for processing by the processor into a corresponding memory based on signals received on general purpose inputs. The DMA controller 110 may be coupled to a graphics controller to provide an indication via signals on general purpose outputs that graphics data for display by the graphics controller has been loaded into a corresponding memory.

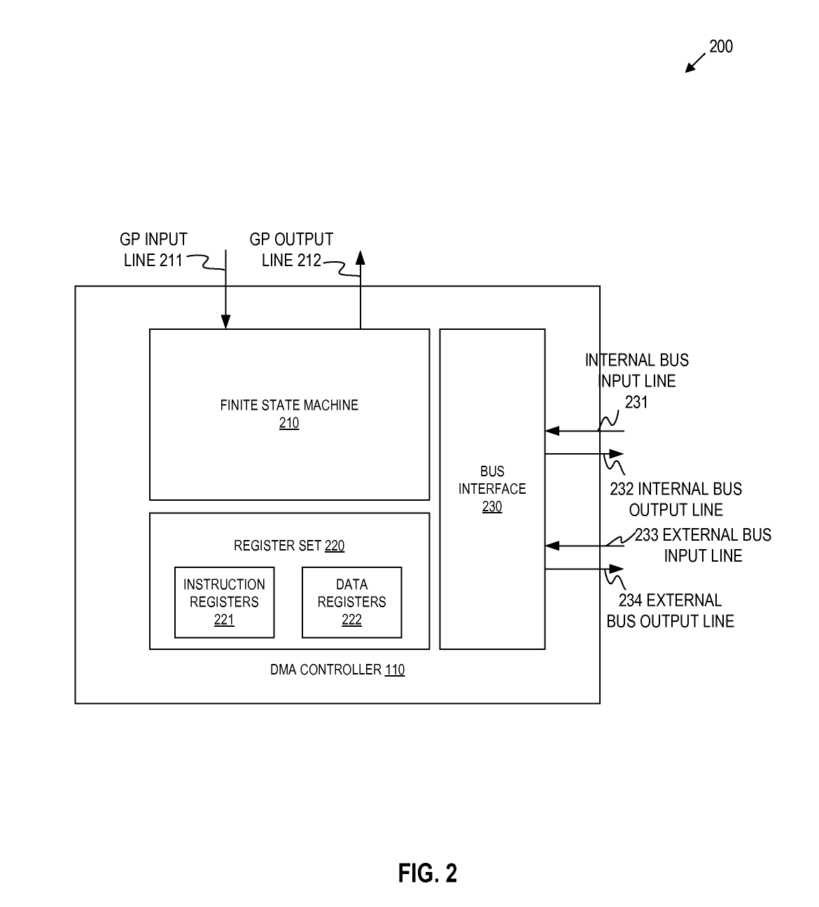

FIG. 2 is a block diagram of a DMA controller 110 in a computer system 200, according to an embodiment of the disclosure. The DMA controller 110 includes a bus interface 230 that couples the DMA controller 110 to an internal bus via an internal bus input line 231 and internal bus output line 232 and couples the DMA controller 110 to an external bus via an external bus input line 233 and external bus output line 234. It is to be appreciated that each of the bus lines 231-234 may include multiple connections allowing multiple bits to be read or written simultaneously. It is also to be appreciated that the bus lines 231-234 may be co-extensive. For example, the internal bus input line 231 may be the same as the internal bus output line 232, which may be a bi-directional internal bus line. Likewise, the external bus input line 233 may be the same as the external bus output line 234. Similarly, the internal bus input line 231 may be the same as external bus input line 233, which may be an input line to a single internal/external bus. Likewise, the internal bus output line 232 may be same as the external bus output line 234.

In one embodiment, the bus interface 230 includes an AHB (Advanced High-Performance Bus) interface to internal memory domains. In another embodiment, the bus interface 230 includes an SRAM (Static Random Access Memory) interface to internal memory domains. In one embodiment, the bus interface 230 includes an OCP (Open Core Protocol) interface to external memory domains.

The DMA controller 110 includes a finite state machine 210 coupled to the bus interface 230. The finite state machine 210 is coupled to a general purpose input (GPI) line 211 of the DMA controller 110 and a general purpose output (GPO) line 212 of the DMA controller 110. In one embodiment, as illustrated in FIG. 1, the GPI line 211 and GPO line 212 may be coupled to a power controller unit.

The finite state machine (FSM) 210 reads input signals from the GPI line 211, the bus interface 230, and a register set 220 and performs operations based on the values of those input signals. For example, the finite state machine 210 may produce one or more output signals to the GPO line 211, the bus interface 230, or the register set 220, where the value of the output signals is based on the value of the input signals.

The register set 220 includes a set of registers that can store data. The register set 220 may include a set of instruction registers 221 for storing one or more descriptors and a set of general purpose data registers 222 to be used for any purpose described by the descriptors. The instruction registers 221 may include four 32-bit registers for storing a descriptor of the format described below with respect to FIGS. 4 and 5. The data registers 222 may include a pair of general purpose registers. Each of the general purpose registers may be 32 bits, or another size. The data registers 222 may also include a flag register to store one or a few status bits.

In one embodiment, the general purpose input line 211 includes a general purpose input register coupled between the line 211 and the FSM 210. Similarly, in one embodiment, the general purpose output line 212 includes a general purpose output register coupled between the line 212 and the FSM 210. Thus, values which are input or output on the lines 211, 212 are “sticky” and may be maintained until changed by the external source or the FSM 210.

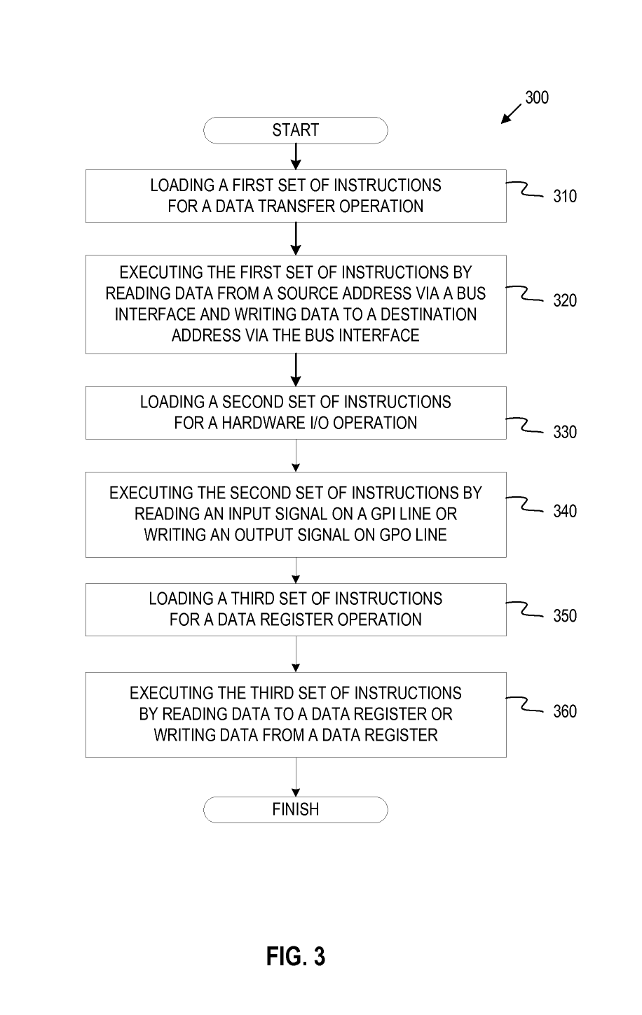

FIG. 3 is a flow diagram illustrating a method 300 of executing instructions, according to one embodiment of the disclosure. The method 300 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, the method 300 may be performed, in part, by processing logic of the DMA controller 110 of FIG. 2. The processing logic may include the finite state machine 210 of the DMA controller 110 of FIG. 2.

For simplicity of explanation, the method 300 is depicted and described as a series of acts. However, acts in accordance with this disclosure can occur in various orders (as described further below) and/or concurrently and with other acts not presented and described herein. Furthermore, not all illustrated acts may be performed to implement the method 300 in accordance with the disclosed subject matter. In addition, those skilled in the art will understand and appreciate that the method 300 could alternatively be represented as a series of interrelated states via a state diagram or events.

At block 310 of method 300, the processing logic loads a first set of instructions for a data transfer operation into a set of instruction registers. The first set of instructions for the data transfer operation may include a source address and a destination address. The first set of instructions for the data transfer operation may also include a memory transfer descriptor. An example layout of a memory transfer descriptor is described below with respect to FIG. 5.

At block 320, the processing logic executes the first set of instructions (e.g., performs the operation described by the descriptor) by transferring data from a first memory location to a second memory location. For example, the processing logic may copy data from a source address to a destination address. In one embodiment, the processing logic reads data, via a bus interface, from a source address specified by a memory transfer descriptor and writes the data, via the bus interface, to a destination address specified by the memory transfer descriptor.

At block 330, the processing logic loads a second set of instructions for a hardware input/output operation into the set of instruction registers. The second set of instructions for the hardware input/output operation may include an output descriptor, an input descriptor, or a branch descriptor. Example layouts of these descriptors are described below with respect to FIG. 5.

At block 340, the processing logic executes the second set of instructions for the hardware input/output operation by reading an input signal on a general purpose input line or writing an output signal on a general purpose output line.

In one embodiment, blocks 310 and 320 are performed before blocks 330 and 340. An example of such an embodiment is described as follow. At block 310, the processing logic loads a first set of instructions for a data transfer operation with instructions to copy all the data from an internal memory domain that is to be switched off. At block 320, the processing logic copies the data from the internal memory domain to an external memory domain (or any other domain that will not be switched off) by reading and writing the data using a bus interface.

The first set of instructions also includes an instruction to load the second set of instructions when execution of the first set of instructions is finished. Thus, at block 330, the processing logic loads the second set of instructions for a hardware input/output operation with instructions to output a signal on the general purpose output line. The output signal indicates to a power controller (coupled to the general purpose output line) that the data of the internal memory domain has been moved and it is safe to switch off the internal memory domain. Then, the power controller switches off the internal memory domain.

In another embodiment, blocks 330 and 340 are performed before blocks 310 and 320. An example of such an embodiment is described as follows. At block 330, the processing logic loads a second set of instructions for a hardware input/output operation with instructions to read an input signal on the general purpose input line. The second set of instructions may be a branch descriptor that includes instructions to load a next set of instructions from a first address if a certain function of the input signal is a first value (e.g., a Boolean logical value such as “FALSE”) and to load a next set of instructions from a second address if the function of the input signal is a second value (e.g., a Boolean logical value such as “TRUE”).

The first address may point to the second set of instructions. Thus, in executing the second set of instructions in block 340, the processing logic is caught in a loop, loading the second set of instructions over and over while the function of the input signal is FALSE. When the function of the input signal is TRUE, the processing logic loads the instructions at the second address. The input signal may be a signal from a power controller indicating that an internal memory domain is switched on (TRUE) or is not switched on (FALSE). Thus, the processing logic waits for the power controller to indicate that the internal memory domain has been switched on before loading the instructions at the second address.

The second address may point to the first set of instructions for a data transfer operation. Thus, the processing logic, at block 310, loads the first set of instructions for a data transfer operation. At block 320, the processing logic executes the first set of instructions by copying data from an external domain into the just switched on internal memory domain using the bus interface.

At block 350, the processing logic may load a third set of instructions for a data register operation into the set of instruction registers. The third set of instructions for the data register operation may include an output descriptor, an input descriptor, or a branch descriptor. Example layouts of these descriptors are described below with respect to FIG. 5.

At block 360, the processing logic executes the third set of instructions for the data register operation by reading data from a general purpose data register or writing data to a general purpose register.

FIG. 4 is a block diagram of an example layout of a generic descriptor 400, according to one embodiment of the disclosure. The descriptor 400 contains four words of 32 bits each which can be loaded into four 32-bit instruction registers of a DMA controller. In other examples, other numbers of words may be used which may be 32 bit words, 64 bit words, 16 bit words, or other sizes. The first word contains a next pointer that indicates the memory address of the next descriptor to be fetched. The first word also contains a descriptor type that instructs the DMA controller as to how to interpret one or more following words (e.g., the following three words). Thus, the other words of the descriptor are dependent on the type of the descriptor as described in a few examples in FIG. 5. In one embodiment, the first word includes a bus-select indicator (which may be a single bit) that indicates which bus the next descriptor (indicated by the memory address in the first word) is to be fetched from.

FIG. 5 is a block diagram of a group of example descriptors, according to one embodiment of the disclosure. A transfer descriptor 510 may be used to describe instructions for a DMA controller to transfer data from a first memory location to a second memory location. The transfer descriptor 510 may, for example, be used to copy data from an internal memory domain to an external memory domain prior to switching off the internal memory domain. Similarly, the transfer descriptor 510 may be used to copy data from an external memory domain to an internal memory domain after the internal memory domain is switched on. The transfer descriptor 510 may be used to move data between internal memory domains, between external memory domains, within an internal memory domain, within an external memory domain, or for other purposes.

The transfer descriptor 510 contains, in one embodiment, four 32-bit words. The first word includes a next pointer that indicates the memory address of the next descriptor to be fetched and a descriptor type indicating that the descriptor 510 is a transfer descriptor. The second word includes a source address value that indicates the source address of the data to be transferred and the third word includes a destination address value that indicates the destination address of the data to be transferred. The fourth word includes a length value that indicates an amount of data to be transferred, starting from the source address and destination address.

In one embodiment, there are two types of transfer descriptors: a unidirectional transfer descriptor (indicated by type ‘000’) and a bidirectional transfer descriptor (indicated by type ‘001’). The unidirectional transfer descriptor transfers data from the source address to the destination address regardless of a mode of the DMA controller. The bidirectional transfer descriptor transfers data from the source address to the destination address when the DMA controller is in a save mode and from the destination address to the source address when the DMA controller is in a restore mode. This allows the same descriptor to be used to save data from an internal memory domain before switching it off and to restore the data to the internal memory domain when it is switched back on. The DMA controller may be placed in the save mode or the restore mode by an external trigger.

An output descriptor 520 may be used to describe instructions for a DMA controller to send an output signal on a general purpose output line. The output descriptor 520 includes a first word with a next pointer and a descriptor type indicating that the descriptor is an output descriptor. The fourth word includes a data source indicator that indicates the initial source of the data that is to be output. The fourth word may indicate that the data source is one of the data registers. The fourth word may indicate that the data source is the second or third word or a function of the second and third word.

If the data source is a data register, the second and third word may be a set mask and a clear mask, respectively, such that the output signal has the value of the data source with bits indicated by the clear mask set to zero and bits indicated by the set mask set to one.

An input descriptor 530 may be used to describe instructions for a DMA controller to receive an input signal on a general purpose input line and store it to a general purpose data register. The input descriptor 520 includes a first word with a next pointer and a descriptor type indicating that the descriptor is an input descriptor. The fourth word includes a data destination indicator that indicates where the input signal is to be stored. The fourth word may indicate that the data destination is one of the data registers. The fourth word may indicate that the data is to be immediately output on a general purpose output line rather than stored.

In one embodiment, the second and third word may be a set mask and a clear mask, respectively, such that the stored data has the value of the input signal with bits indicated by the clear mask set to zero and bits indicated by the set mask set to one.

A branch descriptor 540 may be used to describe instructions for a DMA controller to fetch a next instruction based on a function of a source value. The first word includes a next-true pointer that indicates the memory address of the next descriptor to be fetched if the function of the source value is true and a descriptor type indicating that the descriptor 540 is a branch descriptor. The second word includes a next-false pointer that indicates the memory address of the next descriptor to be fetched if the function of the source value is false and a source value indicator indicating where the source value is to be retrieved. The source value may indicate a general purpose input line or a general purpose data register.

The third and fourth words define the function of the source value. If the value of the function is true (or some other predefined first value), the next-true memory address is used to fetch the next descriptor. If the value of the function is false (or some other predefined second value), the next-false memory address is used to fetch the next descriptor. If the next-false pointer indicates the memory address where the branch descriptor 540 itself is stored, the DMA controller will continue to load the branch descriptor 540 until the function of the value is true.

In one embodiment, the third word is an AND mask and the fourth word is an OR mask. The AND mask can be used to define a first functional input as a sub-function of the source value: an AND of all the bits of the source value corresponding to bits having a ‘1’ value in the AND mask. The OR mask can be used to define a second functional input as a sub-function of the source value: an OR of all the bits of the source value corresponding to bits having a ‘1’ value the OR mask. The value of the function is, thus, an OR of the first and second functional inputs.

The DMA controller may be able to perform other operations based on other descriptor types. Further, although descriptors of four 32-bits words are described herein, it is to be appreciated that descriptors may have more or fewer words. Similarly, although type is indicated by three bits in the examples above, descriptor type may be indicated in other ways or with a different number of bits. For example, descriptor type (or how the DMA controller interprets the descriptor) may be based on an external signal (save as a save/restore trigger) that sets the DMA controller in different modes.

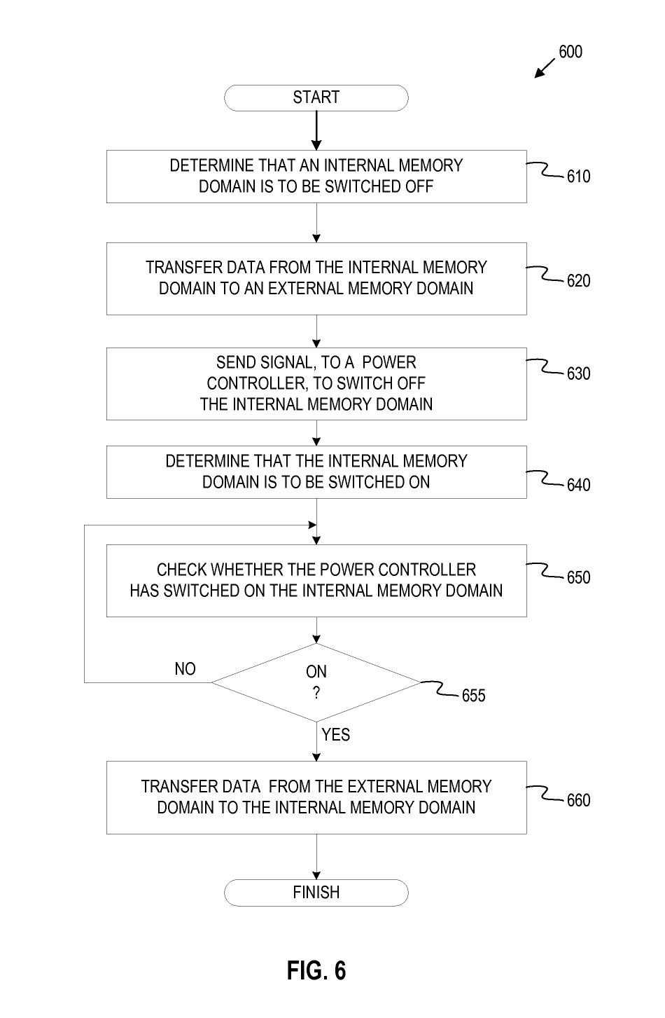

FIG. 6 is a flow diagram illustrating a method of switching off and switching on an internal memory domain, according to one embodiment of the disclosure. The method 600 may be performed by processing logic that may include hardware (e.g., circuitry, dedicated logic, programmable logic, microcode, etc.), software (such as instructions run on a processing device, a general purpose computer system, or a dedicated machine), firmware, or a combination thereof. In one embodiment, method 600 may be performed, in part, by processing logic of the DMA controller 110 of FIG. 1.

At block 610 of method 600, processing logic determines that an internal memory domain is to be switched off. The processing logic may determine that an internal memory domain is to be switched off based on a command from another processing component, e.g., a CPU or a power controller unit.

At block 620, the processing logic, in response to determining that the internal memory domain is to be switched off, transfers data from the internal memory domain to an external memory domain. The processing logic may transfer the data from the internal memory domain to an external memory domain in response to a transfer descriptor indicating a source address of the internal memory domain and a destination address of the external memory domain. The transfer descriptor may also include a next pointer that points to an output descriptor. The transfer descriptor may be fetched in response to a start address included in a trigger provided to the processing logic by a hardware signal or a software write.

At block 630, the processing logic sends a signal to the power controller to switch off the internal memory domain. The processing logic may send the signal on a general purpose output line in response to an output descriptor loaded by the transfer descriptor described above. The output descriptor may include a next pointer that points to a null address indicating that there are no additional descriptors to be fetched by the processing logic at this time. The output descriptor may include a next pointer that points to another output descriptor that causes the processing logic to send the power controller a signal to switch off the processing logic itself.

At block 640, the processing logic determines that the internal memory domain is to be switched on. The processing logic may determine that an internal memory domain is to be switched on based on a command from another processing component, e.g., a CPU or a power controller unit.

At block 650, the processing logic determines whether the power controller has switched on the internal memory domain. The processing logic may determine whether the power controller has switched on the internal memory domain based on an input signal on a general purpose input line. The input signal may be received from the power controller or from the internal memory domain itself.

If it is determined, at block 655, that the internal memory domain has not been switched on, the method 650 returns to block 650 to check. This process may be repeated until it is determined that the internal memory domain has been switched on at block 655. If it is determined that the internal memory domain has been switched on, the method 600 continues to block 660 where the processing logic transfers data into the internal memory domain from an external memory domain.

The operations of block 650, 655, and 660 may be performed with a branch descriptor that includes data source indicator indicating an input signal from a general purpose input line, a function that evaluates as true when the input signal indicates that the internal memory domain is switched on and evaluates as false when the input signal indicates that the internal memory domain is switched off, a next-false pointer that points to the address of the branch descriptor itself, and a next-true point that point to the address of a transfer descriptor for performing the operations of block 660.

As noted above, the DMA controller reads descriptors from an external memory domain. It is to be appreciated that the descriptors are, themselves, data stored in regions of external memory and may be transferred by the DMA controller based on execution of descriptors.

FIG. 7 is a block diagram of a SoC 700 in accordance with an embodiment of the present disclosure. Dashed lined boxes are optional features on more advanced SoCs. In FIG. 7, an interconnect unit(s) 708 is coupled to: an application processor 710 which includes a set of one or more cores 702A-702N and shared cache unit(s) 706; a system agent unit 750; a bus controller unit(s) 716; an integrated memory controller unit(s) 714; a set of one or more media processors 720 which may include integrated graphics logic 722, an image processor 724 for providing still and/or video camera functionality, an audio processor 726 for providing hardware audio acceleration, and a video processor 728 for providing video encode/decode acceleration; a static random access memory (SRAM) unit 730; a direct memory access (DMA) unit 732; and a display unit 740 for coupling to one or more external displays. In one embodiment, the DMA unit 732 includes the DMA controller 110 of FIG. 1.

The memory hierarchy includes one or more levels of cache within the cores, a set or one or more shared cache units 706, and external memory (not shown) coupled to the set of integrated memory controller units 714. The set of shared cache units 706 may include one or more mid-level caches, such as level 2 (L2), level 3 (L3), level 4 (L4), or other levels of cache, a last level cache (LLC), and/or combinations thereof.

In some embodiments, one or more of the cores 702A-702N are capable of multithreading.

The system agent 750 includes those components coordinating and operating cores 702A-702N. The system agent unit 750 may include for example a power control unit (PCU) and a display unit 740. The PCU may be or include logic and components needed for regulating the power state of the cores 702A-702N and the integrated graphics logic 722. The display unit 740 is for driving one or more externally connected displays.

The cores 702A-702N may be homogenous or heterogeneous in terms of architecture and/or instruction set. For example, some of the cores 702A-702N may be in order while others are out-of-order. As another example, two or more of the cores 702A-702N may be capable of execution of the same instruction set, while others may be capable of executing only a subset of that instruction set or a different instruction set.

The application processor 710 may be a general-purpose processor, such as a Core™ i3, i5, i7, 2 Duo and Quad, Xeon™, Xeon-Phi™, Itanium™, XScale™ or StrongARM™ processor, which are available from Intel Corporation, of Santa Clara, Calif. Alternatively, the application processor 710 may be from another company, such as ARM Holdings, Ltd, MIPS, etc. The application processor 710 may be a special-purpose processor, such as, for example, a network or communication processor, compression engine, graphics processor, co-processor, embedded processor, or the like. The application processor 710 may be implemented on one or more chips. The application processor 710 may be a part of and/or may be implemented on one or more substrates using any of a number of process technologies, such as, for example, BiCMOS, CMOS, or NMOS.

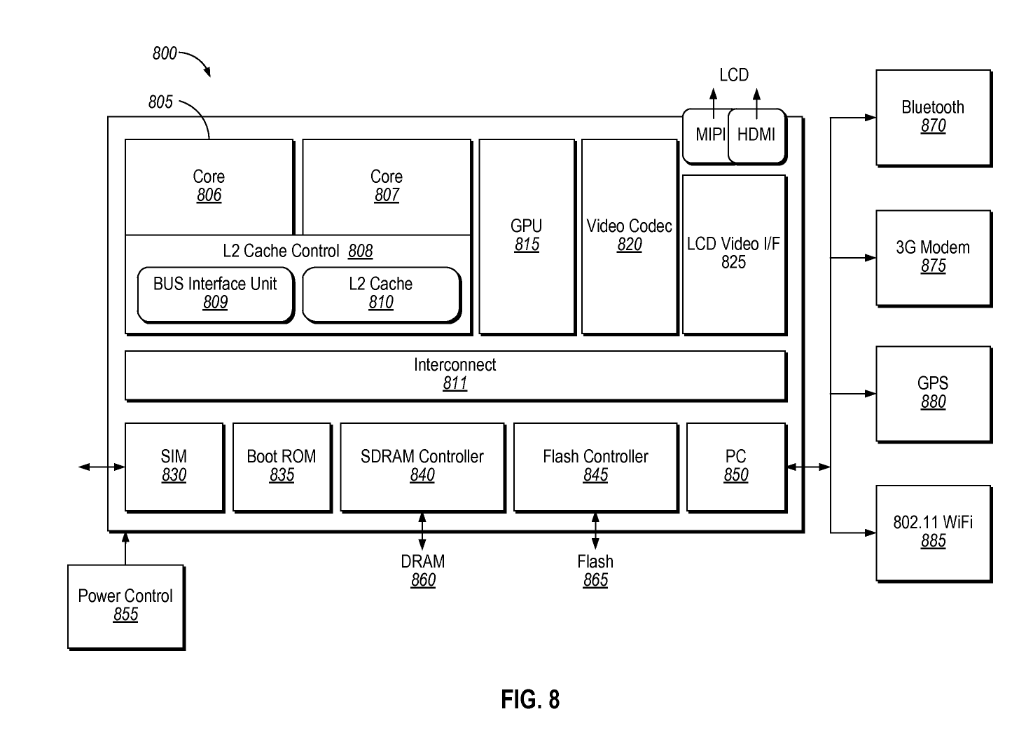

FIG. 8 is a block diagram of an embodiment of a system on-chip (SOC) design in accordance with the present disclosure. As a specific illustrative example, SOC 800 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network. In one embodiment, the SOC may include the DMA controller 110 of FIG. 1. For example, the SDRAM controller 840 or flash controller 845 may include functionality described above with respect to the DMA 110 controller of FIG. 1.

Here, SOC 800 includes 2 cores—806 and 807. Cores 806 and 807 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 806 and 807 are coupled to cache control 808 that is associated with bus interface unit 809 and L2 cache 810 to communicate with other parts of system 800. Interconnect 811 includes an on-chip interconnect, such as an IOSF, AMBA, or other interconnect discussed above, which potentially implements one or more aspects of the described disclosure.

Interface 811 provides communication channels to the other components, such as a Subscriber Identity Module (SIM) 830 to interface with a SIM card, a boot ROM 835 to hold boot code for execution by cores 806 and 807 to initialize and boot SOC 800, a SDRAM controller 840 to interface with external memory (e.g. DRAM 860), a flash controller 845 to interface with non-volatile memory (e.g. Flash 865), a peripheral control 850 (e.g. Serial Peripheral Interface) to interface with peripherals, video codecs 820 and Video interface 825 to display and receive input (e.g. touch enabled input), GPU 815 to perform graphics related computations, etc. Any of these interfaces may incorporate aspects of the disclosure described herein.

In addition, the system 800 illustrates peripherals for communication, such as a Bluetooth module 870, 3G modem 875, GPS 880, and Wi-Fi 885. Note as stated above, a UE includes a radio for communication. As a result, these peripheral communication modules are not all required. However, in a UE, some form of a radio for external communication is to be included.

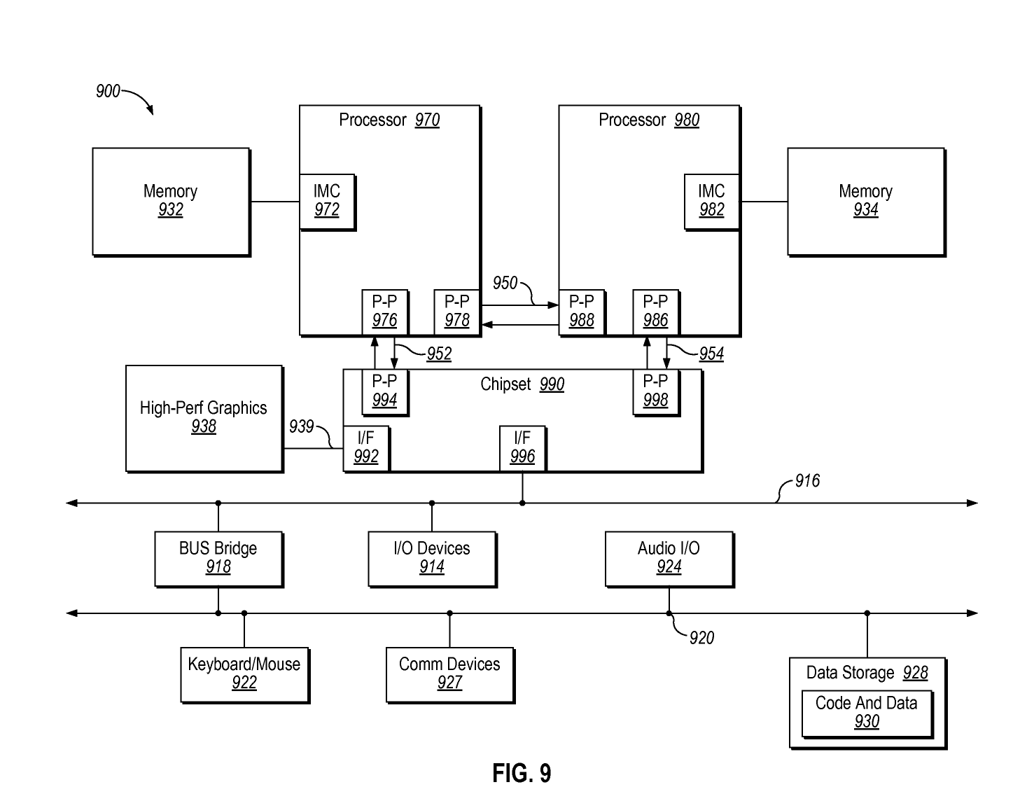

FIG. 9 is a block diagram of a multiprocessor system 900 in accordance with an implementation. As shown in FIG. 9, multiprocessor system 900 is a point-to-point interconnect system, and includes a first processor 970 and a second processor 980 coupled via a point-to-point interconnect 950. Each of processors 970 and 980 may be some version of the processing device 140A-140C of FIG. 1. As shown in FIG. 9, each of processors 970 and 980 may be multicore processors, including first and second processor cores, although potentially many more cores may be present in the processors. A processor core may also be referred to as an execution core. In one embodiment, the chipset 990 may include a DMA controller 110 as described above with respect to FIG. 1.

While shown with two processors 970, 980, it is to be understood that the scope of the present disclosure is not so limited. In other implementations, one or more additional processors may be present in a given processor.

Processors 970 and 980 are shown including integrated memory controller units 972 and 982, respectively. Processor 970 also includes as part of its bus controller units point-to-point (P-P) interfaces 976 and 978; similarly, second processor 980 includes P-P interfaces 986 and 988. Processors 970, 980 may exchange information via a point-to-point (P-P) interface 950 using P-P interface circuits 978, 988. As shown in FIG. 9, IMCs 972 and 982 couple the processors to respective memories, namely a memory 932 and a memory 934, which may be portions of main memory locally attached to the respective processors.

Processors 970, 980 may each exchange information with a chipset 990 via individual P-P interfaces 952, 954 using point to point interface circuits 976, 994, 986, and 998. Chipset 990 may also exchange information with a high-performance graphics circuit 938 via a high-performance graphics interface 939.

A shared cache (not shown) may be included in either processor or outside of both processors, yet connected with the processors via P-P interconnect, such that either or both processors' local cache information may be stored in the shared cache if a processor is placed into a low power mode.

Chipset 990 may be coupled to a first bus 916 via an interface 996. In one embodiment, first bus 916 may be a Peripheral Component Interconnect (PCI) bus, or a bus such as a PCI Express bus or another third generation I/O interconnect bus, although the scope of the present disclosure is not so limited.

As shown in FIG. 9, various I/O devices 914 may be coupled to first bus 916, along with a bus bridge 918 which couples first bus 916 to a second bus 920. In one embodiment, second bus 920 may be a low pin count (LPC) bus. Various devices may be coupled to second bus 920 including, for example, a keyboard and/or mouse 922, communication devices 927 and a storage unit 928 such as a disk drive or other mass storage device which may include instructions/code and data 930, in one embodiment. Further, an audio I/O 924 may be coupled to second bus 920. Note that other architectures are possible. For example, instead of the point-to-point architecture of FIG. 9, a system may implement a multi-drop bus or other such architecture.

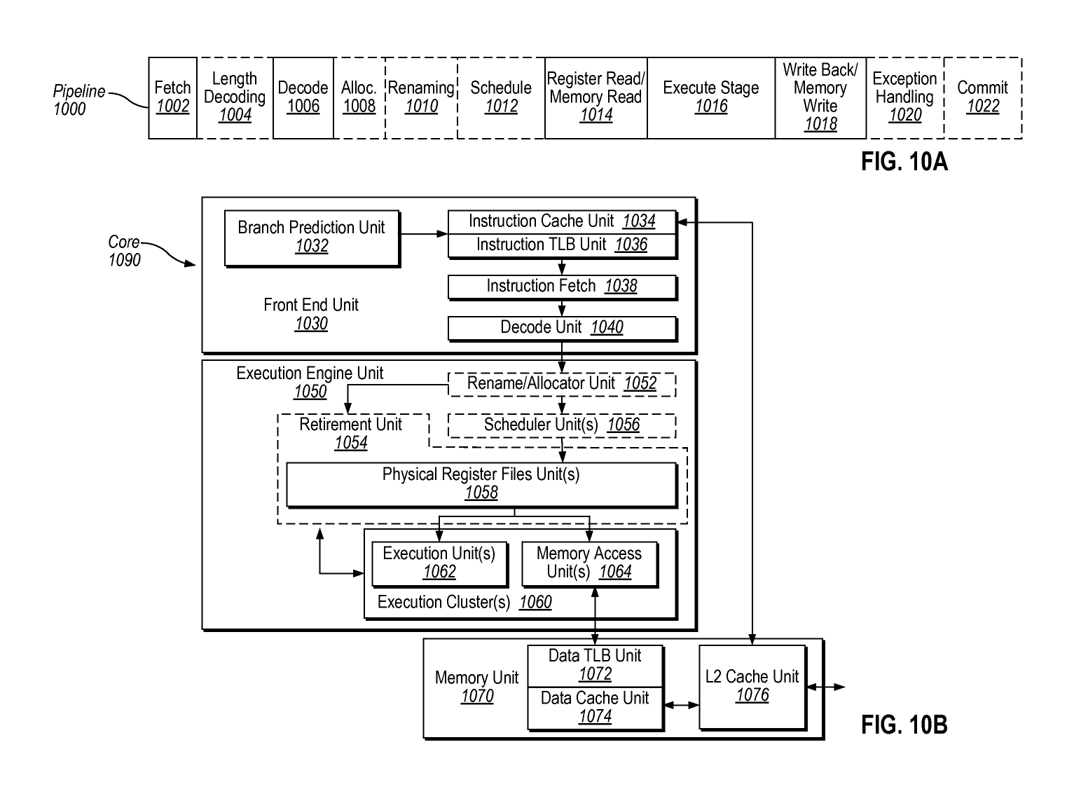

FIG. 10A is a block diagram illustrating an in-order pipeline and a register renaming stage, out-of-order issue/execution pipeline implemented by core 1090 of FIG. 10B (which may be include in a processor). FIG. 10B is a block diagram illustrating an in-order architecture core and a register renaming logic, out-of-order issue/execution logic that may be included in a processor according to at least one embodiment of the invention. The solid lined boxes in FIG. 10A illustrate the in-order pipeline, while the dashed lined boxes illustrates the register renaming, out-of-order issue/execution pipeline. Similarly, the solid lined boxes in FIG. 10A illustrate the in-order architecture logic, while the dashed lined boxes illustrates the register renaming logic and out-of-order issue/execution logic. In FIG. 10A, a processor pipeline 1000 includes a fetch stage 1002, a length decode stage 1004, a decode stage 1006, an allocation stage 1008, a renaming stage 1010, a scheduling (also known as a dispatch or issue) stage 1012, a register read/memory read stage 1014, an execute stage 1016, a write back/memory write stage 1018, an exception handling stage 1020, and a commit stage 1022. In one embodiment, the DMA controller 110 of FIG. 1 may include some or all of the functionality of the core 1090. In another embodiment, the core 1090 is coupled to and communicates with a DMA controller such as the DMA controller 110 of FIG. 1.

FIG. 10B is a block diagram illustrating an in-order architecture core and a register renaming logic, out-of-order issue/execution logic that may be included in a processor according to at least one embodiment of the disclosure. In FIG. 10B, arrows denote a coupling between two or more units and the direction of the arrow indicates a direction of data flow between those units. FIG. 10B shows processor core 1090 including a front end unit 1030 coupled to an execution engine unit 1050, and both are coupled to a memory unit 1070.

The core 1090 may be a reduced instruction set computing (RISC) core, a complex instruction set computing (CISC) core, a very long instruction word (VLIW) core, or a hybrid or alternative core type. As yet another option, the core 1090 may be a special-purpose core, such as, for example, a network or communication core, compression engine, graphics core, or the like.

The front end unit 1030 includes a branch prediction unit 1032 coupled to an instruction cache unit 1034, which is coupled to an instruction translation lookaside buffer (TLB) 1036, which is coupled to an instruction fetch unit 1038, which is coupled to a decode unit 1040. The decode unit or decoder may decode instructions, and generate as an output one or more micro-operations, micro-code entry points, microinstructions, other instructions, or other control signals, which are decoded from, or which otherwise reflect, or are derived from, the original instructions. The decoder may be implemented using various different mechanisms. Examples of suitable mechanisms include, but are not limited to, look-up tables, hardware implementations, programmable logic arrays (PLAs), microcode read only memories (ROMs), etc. The instruction cache unit 1034 is further coupled to a level 2 (L2) cache unit 1076 in the memory unit 1070. The decode unit 1040 is coupled to a rename/allocator unit 1052 in the execution engine unit 1050.

The execution engine unit 1050 includes the rename/allocator unit 1052 coupled to a retirement unit 1054 and a set of one or more scheduler unit(s) 1056. The scheduler unit(s) 1056 represents any number of different schedulers, including reservations stations, central instruction window, etc. The scheduler unit(s) 1056 is coupled to the physical register file(s) unit(s) 1058. Each of the physical register file(s) units 1058 represents one or more physical register files, different ones of which store one or more different data types, such as scalar integer, scalar floating point, packed integer, packed floating point, vector integer, vector floating point, etc., status (e.g., an instruction pointer that is the address of the next instruction to be executed), etc. The physical register file(s) unit(s) 1058 is overlapped by the retirement unit 1054 to illustrate various ways in which register renaming and out-of-order execution may be implemented (e.g., using a reorder buffer(s) and a retirement register file(s), using a future file(s), a history buffer(s), and a retirement register file(s); using a register maps and a pool of registers; etc.). Generally, the architectural registers are visible from the outside of the processor or from a programmer's perspective. The registers are not limited to any known particular type of circuit. Various different types of registers are suitable as long as they are capable of storing and providing data as described herein. Examples of suitable registers include, but are not limited to, dedicated physical registers, dynamically allocated physical registers using register renaming, combinations of dedicated and dynamically allocated physical registers, etc. The retirement unit 1054 and the physical register file(s) unit(s) 1058 are coupled to the execution cluster(s) 1060. The execution cluster(s) 1060 includes a set of one or more execution units 1062 and a set of one or more memory access units 1064. The execution units 1062 may perform various operations (e.g., shifts, addition, subtraction, multiplication) and on various types of data (e.g., scalar floating point, packed integer, packed floating point, vector integer, vector floating point). While some embodiments may include a number of execution units dedicated to specific functions or sets of functions, other embodiments may include only one execution unit or multiple execution units that all perform all functions. The scheduler unit(s) 1056, physical register file(s) unit(s) 1058, and execution cluster(s) 1060 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler unit, physical register file(s) unit, and/or execution cluster—and in the case of a separate memory access pipeline, certain embodiments are implemented in which only the execution cluster of this pipeline has the memory access unit(s) 1064). It should also be understood that where separate pipelines are used, one or more of these pipelines may be out-of-order issue/execution and the rest in-order.

The set of memory access units 1064 is coupled to the memory unit 1070, which includes a data TLB unit 1072 coupled to a data cache unit 1074 coupled to a level 2 (L2) cache unit 1076. In one exemplary embodiment, the memory access units 1064 may include a load unit, a store address unit, and a store data unit, each of which is coupled to the data TLB unit 1072 in the memory unit 1070. The L2 cache unit 1076 is coupled to one or more other levels of cache and eventually to a main memory.

By way of example, the exemplary register renaming, out-of-order issue/execution core architecture may implement the pipeline 1000 as follows: 1) the instruction fetch 1038 performs the fetch and length decoding stages 1002 and 1004; 2) the decode unit 1040 performs the decode stage 1006; 3) the rename/allocator unit 1052 performs the allocation stage 1008 and renaming stage 1010; 4) the scheduler unit(s) 1056 performs the schedule stage 1012; 5) the physical register file(s) unit(s) 1058 and the memory unit 1070 perform the register read/memory read stage 1014; the execution cluster 1060 perform the execute stage 1016; 6) the memory unit 1070 and the physical register file(s) unit(s) 1058 perform the write back/memory write stage 1018; 7) various units may be involved in the exception handling stage 1020; and 8) the retirement unit 1054 and the physical register file(s) unit(s) 1058 perform the commit stage 1022.

The core 1090 may support one or more instructions sets (e.g., the x86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.).

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache units 1034/1074 and a shared L2 cache unit 1076, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

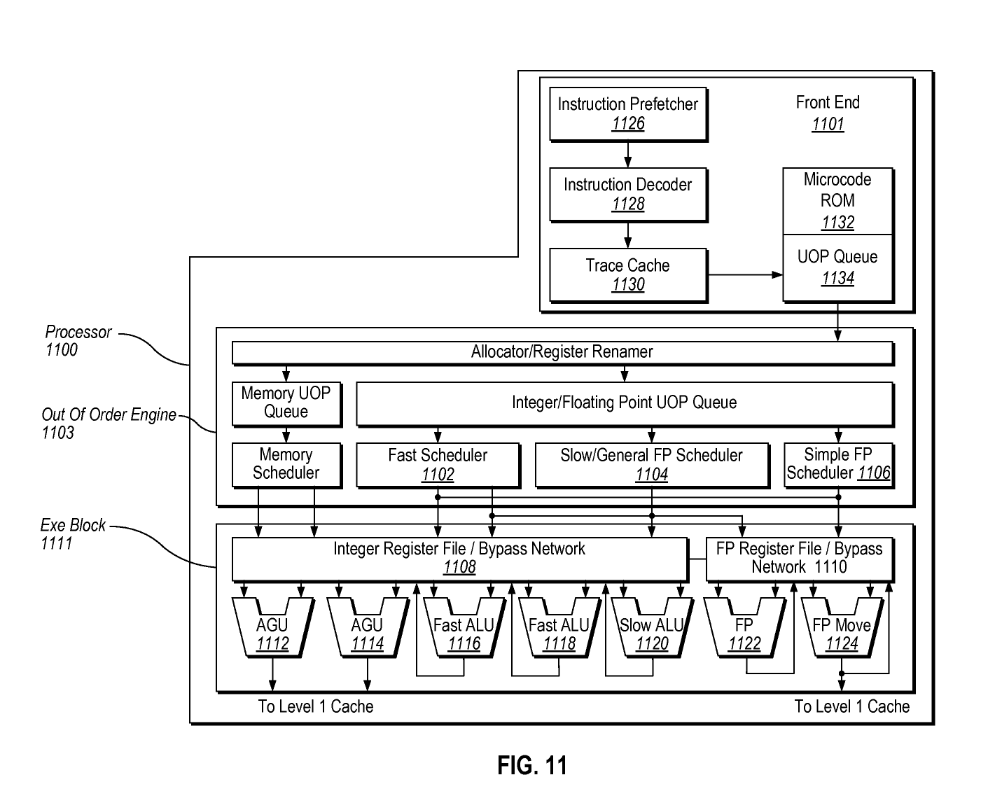

FIG. 11 is a block diagram of the micro-architecture for a processor 1100 that includes logic circuits to perform instructions in accordance with one embodiment of the present invention. In some embodiments, an instruction in accordance with one embodiment can be implemented to operate on data elements having sizes of byte, word, doubleword, quadword, etc., as well as datatypes, such as single and double precision integer and floating point datatypes. In one embodiment the in-order front end 1101 is the part of the processor 1100 that fetches instructions to be executed and prepares them to be used later in the processor pipeline. The front end 1101 may include several units. In one embodiment, the instruction prefetcher 1126 fetches instructions from memory and feeds them to an instruction decoder 1128 which in turn decodes or interprets them. For example, in one embodiment, the decoder decodes a received instruction into one or more operations called “micro-instructions” or “micro-operations” (also called micro op or uops) that the machine can execute. In other embodiments, the decoder parses the instruction into an opcode and corresponding data and control fields that are used by the micro-architecture to perform operations in accordance with one embodiment. In one embodiment, the trace cache 1130 takes decoded uops and assembles them into program ordered sequences or traces in the uop queue 1134 for execution. When the trace cache 1130 encounters a complex instruction, the microcode ROM 1132 provides the uops needed to complete the operation. In one embodiment, the DMA controller 110 of FIG. 1 may include some or all of the components and functionality of the processor 1100. In another embodiment, the processor 1100 is coupled to and communicates with a DMA controller such as the DMA controller 110 of FIG. 1.

Some instructions are converted into a single micro-op, whereas others need several micro-ops to complete the full operation. In one embodiment, if more than four micro-ops are needed to complete an instruction, the decoder 1128 accesses the microcode ROM 1132 to do the instruction. For one embodiment, an instruction can be decoded into a small number of micro ops for processing at the instruction decoder 1128. In another embodiment, an instruction can be stored within the microcode ROM 1132 should a number of micro-ops be needed to accomplish the operation. The trace cache 1130 refers to an entry point programmable logic array (PLA) to determine a correct micro-instruction pointer for reading the micro-code sequences to complete one or more instructions in accordance with one embodiment from the micro-code ROM 1132. After the microcode ROM 1132 finishes sequencing micro-ops for an instruction, the front end 1101 of the machine resumes fetching micro-ops from the trace cache 1130.

The out-of-order execution engine 1103 is where the instructions are prepared for execution. The out-of-order execution logic has a number of buffers to smooth out and re-order the flow of instructions to optimize performance as they go down the pipeline and get scheduled for execution. The allocator logic allocates the machine buffers and resources that each uop needs in order to execute. The register renaming logic renames logic registers onto entries in a register file. The allocator also allocates an entry for each uop in one of the two uop queues, one for memory operations and one for non-memory operations, in front of the instruction schedulers: memory scheduler, fast scheduler 1102, slow/general floating point scheduler 1104, and simple floating point scheduler 1106. The uop schedulers 1102, 1104, 1106, determine when a uop is ready to execute based on the readiness of their dependent input register operand sources and the availability of the execution resources the uops need to complete their operation. The fast scheduler 1102 of one embodiment can schedule on each half of the main clock cycle while the other schedulers can only schedule once per main processor clock cycle. The schedulers arbitrate for the dispatch ports to schedule uops for execution.

Register files 1108, 1110, sit between the schedulers 1102, 1104, 1106, and the execution units 1112, 1114, 1116, 1118, 1120, 1122, and 1124 in the execution block 1111. There is a separate register file 1108, 1110, for integer and floating point operations, respectively. Each register file 1108, 1110, of one embodiment also includes a bypass network that can bypass or forward just completed results that have not yet been written into the register file to new dependent uops. The integer register file 1108 and the floating point register file 1110 are also capable of communicating data with the other. For one embodiment, the integer register file 1108 is split into two separate register files, one register file for the low order 32 bits of data and a second register file for the high order 32 bits of data. The floating point register file 1110 of one embodiment has 128 bit wide entries because floating point instructions typically have operands from 64 to 128 bits in width.

The execution block 1111 contains the execution units 1112, 1114, 1116, 1118, 1120, 1122, 1124, where the instructions are actually executed. This section includes the register files 1108, 1110, that store the integer and floating point data operand values that the micro-instructions need to execute. The processor 1100 of one embodiment is comprised of a number of execution units: address generation unit (AGU) 1112, AGU 1114, fast ALU 1116, fast ALU 1118, slow ALU 1120, floating point ALU 1122, floating point move unit 1124. For one embodiment, the floating point execution blocks 1122, 1124, execute floating point, MMX, SIMD, and SSE, or other operations. The floating point ALU 1122 of one embodiment includes a 64 bit by 64 bit floating point divider to execute divide, square root, and remainder micro-ops. For embodiments of the present invention, instructions involving a floating point value may be handled with the floating point hardware. In one embodiment, the ALU operations go to the high-speed ALU execution units 1116, 1118. The fast ALUs 1116, 1118, of one embodiment can execute fast operations with an effective latency of half a clock cycle. For one embodiment, most complex integer operations go to the slow ALU 1120 as the slow ALU 1120 includes integer execution hardware for long latency type of operations, such as a multiplier, shifts, flag logic, and branch processing. Memory load/store operations are executed by the AGUs 1112, 1114. For one embodiment, the integer ALUs 1116, 1118, 1120, are described in the context of performing integer operations on 64 bit data operands. In alternative embodiments, the ALUs 1116, 1118, 1120, can be implemented to support a variety of data bits including 16, 32, 128, 256, etc. Similarly, the floating point units 1122, 1124, can be implemented to support a range of operands having bits of various widths. For one embodiment, the floating point units 1122, 1124, can operate on 128 bits wide packed data operands in conjunction with SIMD and multimedia instructions.

In one embodiment, the uops schedulers 1102, 1104, 1106, dispatch dependent operations before the parent load has finished executing. As uops are speculatively scheduled and executed in processor 1100, the processor 1100 also includes logic to handle memory misses. If a data load misses in the data cache, there can be dependent operations in flight in the pipeline that have left the scheduler with temporarily incorrect data. A replay mechanism tracks and re-executes instructions that use incorrect data. Only the dependent operations need to be replayed and the independent ones are allowed to complete. The schedulers and replay mechanism of one embodiment of a processor are also designed to catch instruction sequences for text string comparison operations.

The term “registers” may refer to the on-board processor storage locations that are used as part of instructions to identify operands. In other words, registers may be those that are usable from the outside of the processor (from a programmer's perspective). However, the registers of an embodiment should not be limited in meaning to a particular type of circuit. Rather, a register of an embodiment is capable of storing and providing data, and performing the functions described herein. The registers described herein can be implemented by circuitry within a processor using any number of different techniques, such as dedicated physical registers, dynamically allocated physical registers using register renaming, combinations of dedicated and dynamically allocated physical registers, etc. In one embodiment, integer registers store thirty-two bit integer data. A register file of one embodiment also contains eight multimedia SIMD registers for packed data. For the discussions below, the registers are understood to be data registers designed to hold packed data, such as 64 bits wide MMX™ registers (also referred to as ‘mm’ registers in some instances) in microprocessors enabled with MMX technology from Intel Corporation of Santa Clara, Calif. These MMX registers, available in both integer and floating point forms, can operate with packed data elements that accompany SIMD and SSE instructions. Similarly, 128 bits wide XMM registers relating to SSE2, SSE3, SSE4, or beyond (referred to generically as “SSEx”) technology can also be used to hold such packed data operands. In one embodiment, in storing packed data and integer data, the registers do not need to differentiate between the two data types. In one embodiment, integer and floating point are either contained in the same register file or different register files. Furthermore, in one embodiment, floating point and integer data may be stored in different registers or the same registers.

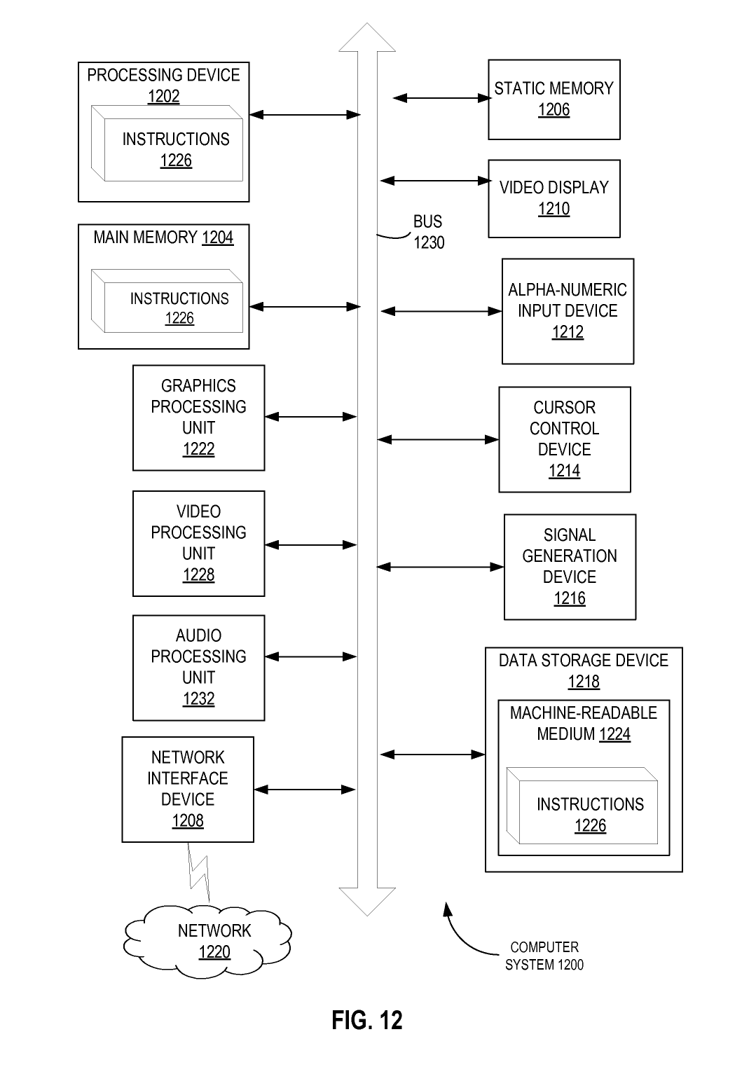

FIG. 12 illustrates a diagrammatic representation of a machine in the example form of a computer system 1200 within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server or a client device in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a smartphone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, the computer system 1200 may further include the DMA controller 110 of FIG. 1.

The computer system 1200 includes a processing device 1202, a main memory 1204 (e.g., read-only memory (ROM), flash memory, dynamic random access memory (DRAM) (such as synchronous DRAM (SDRAM) or DRAM (RDRAM), etc.), a static memory 1206 (e.g., flash memory, static random access memory (SRAM), etc.), and a data storage device 1218, which communicate with each other via a bus 1230.

Processing device 1202 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 1202 may also be one or more special-purpose processing devices such as an application specific integrated circuit (ASIC), a field programmable gate array (FPGA), a digital signal processor (DSP), network processor, or the like. In one embodiment, processing device 1202 may include one or more processing cores. The processing device 1202 is configured to execute the instructions 1226 of a mirroring logic for performing the operations discussed herein.

The computer system 1200 may further include a network interface device 1208 communicably coupled to a network 1220. The computer system 1200 also may include a video display unit 1210 (e.g., a liquid crystal display (LCD) or a cathode ray tube (CRT)), an alphanumeric input device 1212 (e.g., a keyboard), a cursor control device 1214 (e.g., a mouse), a signal generation device 1216 (e.g., a speaker), or other peripheral devices. Furthermore, computer system 1200 may include a graphics processing unit 1222, a video processing unit 1228, and an audio processing unit 1232. In another embodiment, the computer system 1200 may include a chipset (not illustrated), which refers to a group of integrated circuits, or chips, that are designed to work with the processing device 1202 and controls communications between the processing device 1202 and external devices. For example, the chipset may be a set of chips on a motherboard that links the processing device 1202 to very high-speed devices, such as main memory 1204 and graphic controllers, as well as linking the processing device 1202 to lower-speed peripheral buses of peripherals, such as USB, PCI or ISA buses.

The data storage device 1218 may include a computer-readable storage medium 1224 on which is stored instructions 1226 embodying any one or more of the methodologies of functions described herein. The instructions 1226 may also reside, completely or at least partially, within the main memory 1204 and/or within the processing device 1202 during execution thereof by the computer system 1200; the main memory 1204 and the processing device 1202 also constituting computer-readable storage media.

The computer-readable storage medium 1224 may also be used to store instructions 1226 utilizing logic and/or a software library containing methods that call the above applications. While the computer-readable storage medium 1224 is shown in an example embodiment to be a single medium, the term “computer-readable storage medium” or “computer-readable medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instruction for execution by the machine and that cause the machine to perform any one or more of the methodologies of the present embodiments. The term “computer-readable storage medium” shall accordingly be taken to include, but not be limited to, solid-state memories, and optical and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Although the embodiments may be herein described with reference to specific integrated circuits, such as in computing platforms or microprocessors, other embodiments are applicable to other types of integrated circuits and logic devices. Similar techniques and teachings of embodiments described herein may be applied to other types of circuits or semiconductor devices. For example, the disclosed embodiments are not limited to desktop computer systems or Ultrabooks™ and may be also used in other devices, such as handheld devices, tablets, other thin notebooks, systems on a chip (SOC) devices, and embedded applications. Some examples of handheld devices include cellular phones, Internet protocol devices, smartphones, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below.

Although the embodiments are herein described with reference to a processor or processing device, other embodiments are applicable to other types of integrated circuits and logic devices. Similar techniques and teachings of embodiments of the present invention can be applied to other types of circuits or semiconductor devices that can benefit from higher pipeline throughput and improved performance. The teachings of embodiments of the present invention are applicable to any processor or machine that performs data manipulations. However, the present invention is not limited to processors or machines that perform 512 bit, 256 bit, 128 bit, 64 bit, 32 bit, and/or 16 bit data operations and can be applied to any processor and machine in which manipulation or management of data is performed. In addition, the following description provides examples, and the accompanying drawings show various examples for the purposes of illustration. However, these examples should not be construed in a limiting sense as they are merely intended to provide examples of embodiments of the present invention rather than to provide an exhaustive list of all possible implementations of embodiments of the present invention.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like. The blocks described herein can be hardware, software, firmware, or a combination thereof.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “detecting,” “initiating,” “determining,” “continuing,” “halting,” “receiving,” “recording,” or the like, refer to the actions and processes of a computing system, or similar electronic computing device, that manipulates and transforms data represented as physical (e.g., electronic) quantities within the computing system's registers and memories into other data similarly represented as physical quantities within the computing system memories or registers or other such information storage, transmission or display devices.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. Also, the terms “first,” “second,” “third,” “fourth,” etc. as used herein are meant as labels to distinguish among different elements and may not necessarily have an ordinal meaning according to their numerical designation.

Embodiments described herein may also relate to an apparatus for performing the operations herein. This apparatus may be specially constructed for the required purposes, or it may comprise a general-purpose computer selectively activated or reconfigured by a computer program stored in the computer. Such a computer program may be stored in a non-transitory computer-readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory, or any type of media suitable for storing electronic instructions. The term “computer-readable storage medium” should be taken to include a single medium or multiple media (e.g., a centralized or distributed database and/or associated caches and servers) that store the one or more sets of instructions. The term “computer-readable medium” shall also be taken to include any medium that is capable of storing, encoding or carrying a set of instructions for execution by the machine and that causes the machine to perform any one or more of the methodologies of the present embodiments. The term “computer-readable storage medium” shall accordingly be taken to include, but not be limited to, solid-state memories, optical media, magnetic media, any medium that is capable of storing a set of instructions for execution by the machine and that causes the machine to perform any one or more of the methodologies of the present embodiments.

The algorithms and displays presented herein are not inherently related to any particular computer or other apparatus. Various general-purpose systems may be used with programs in accordance with the teachings herein, or it may prove convenient to construct a more specialized apparatus to perform the operations. The required structure for a variety of these systems will appear from the description below. In addition, the present embodiments are not described with reference to any particular programming language. It will be appreciated that a variety of programming languages may be used to implement the teachings of the embodiments as described herein.

The above description sets forth numerous specific details such as examples of specific systems, components, methods and so forth, in order to provide a good understanding of several embodiments. It will be apparent to one skilled in the art, however, that at least some embodiments may be practiced without these specific details. In other instances, well-known components or methods are not described in detail or are presented in simple block diagram format in order to avoid unnecessarily obscuring the present embodiments. Thus, the specific details set forth above are merely exemplary. Particular implementations may vary from these exemplary details and still be contemplated to be within the scope of the present embodiments.

It is to be understood that the above description is intended to be illustrative and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A method comprising:
loading, into a set of instruction registers of a direct memory access (DMA) controller, a first set of instructions for a transfer operation, the first set of instructions for the transfer operation including a source address and a destination address;
executing, by the DMA controller, the first set of instructions for the transfer operation by reading data from the source address via a bus interface of the DMA controller and writing the data to the destination address via the bus interface;
loading, into the set of instruction registers, a second set of instructions for a hardware operation;
executing, by the DMA controller, the second set of instructions for the hardware operation by reading an input signal on an input line of the DMA controller or writing an output signal on an output line of the DMA controller.

2. The method of claim 1, wherein the first set of instructions are loaded before the second set of instructions are loaded, wherein the first set of instructions for the transfer operation includes a source address of an internal memory domain and a destination address of an external memory domain, and wherein the second set of instructions for the hardware operation includes instructions to write the output signal on the output line to a power controller, the output signal directing the power controller to switch off the internal memory domain.

3. The method of claim 1, wherein the second set of instructions are loaded before the first set of instructions are loaded, wherein the second set of instructions for the hardware operation includes instructions to read the input signal on the input line from a power controller to determine whether an internal memory domain is switched on, and wherein the first set of instructions for the transfer operation includes a source memory address of an external memory domain and a destination address of the internal memory domain.

4. The method of claim 1,
wherein executing the second set of instructions for the hardware operation comprises:
reading the input signal on the input line to determine an address for a next set of instructions; and
loading, into the set of instruction registers, the next of instructions; and
wherein the method further comprising executing, by the DMA controller, the next set of instructions.

5. The method of claim 4, wherein the address for the next set of instructions points to the second set of instructions while a function of the input signal is a first value and wherein the address for the next set of instructions points to a different set of instructions when the function is a second value.

6. The method of claim 1, further comprising:
loading, into the set of instruction registers, a third set of instructions for a data register operation;
executing, by the DMA controller, the instructions for the data register operation by reading data from or writing data to a data register of the DMA controller.

7. The method of claim 1, wherein the set of instruction registers comprises four 32-bit registers, one of the 32-bit registers for storing a next instruction address and a type descriptor for a set of instructions, others of the 32-bits registers for storing values dependent on the type descriptor.

8. A device comprising:
a bus interface coupled to an internal memory domain and an external memory domain;
an input line and an output line;
a set of instruction registers to store, at a first time, a first set of instructions for a transfer operation including a source address and a destination address and to store, at a second time, a second set of instructions for a hardware operation; and
a processing unit to execute, at the first time, the first set of instructions for the transfer operation by reading data from the source address via the bus interface and writing the data to the destination address via the bus interface and to execute, at the second time, the second set of instructions for the hardware operation by reading an input signal on the input line or writing an output signal on the output line.

9. The device of claim 8, wherein the first time is prior to the second time, wherein the first set of instructions for the transfer operation includes a source address of the internal memory and a destination address of the external memory domain, and wherein the second set of instructions for the hardware operation includes instructions to write the output signal on the output line to a power controller, the output signal directing the power controller to switch off the internal memory domain.

10. The device of claim 8, wherein the second time is prior to the first time, wherein the second set of instructions for the hardware operation includes instructions to read the input signal on the input line from a power controller to determine whether the internal memory domain is switched on, and wherein the first set of instructions includes a source memory address of the external memory domain and a destination address of the internal memory domain.

11. The device of claim 8, wherein processing unit executes the second set of instructions for the hardware operation by:
reading the input signal on the input line to determine an address for a next set of instructions; and
loading, into the set of instruction registers, the next set of instructions.

12. The device of claim 8, wherein the address for the next set of instructions points to the second set of instructions while a function of the input signal is a first value and wherein the address for the next set of instructions points to a different set of instructions while the function is a second value points to a different set of instructions when the function is a second value.

13. The device of claim 8, further comprising a set of data registers, the set of instruction registers to store, at a third time, a third set of instructions for a data register operation and the processing unit to execute, at the third time, the third set of instructions for the data register operation by reading data from or writing data to one of the set of data registers.

14. A computer system comprising:
an internal memory domain;
an external memory domain;
a power controller unit to switch on and switch off the internal memory domain; and
a direct memory access (DMA) controller coupled to internal memory domain and the external memory domain by a bus interface and coupled to the power controller unit by an input line and an output line, the DMA controller to read instructions from the external memory domain and execute the instructions, the instructions including a first set of instructions to transfer memory between the internal memory domain and the external memory domain and second set of instructions to read an input signal on the input line or write an output signal on the output line.

15. The computer system of claim 14, wherein the first set of instructions includes a source address of the internal memory domain and the destination address of the external memory domain and the second set of instructions includes instructions to write the output signal on the output line directing the power controller unit to switch off the internal memory domain.

16. The computer system of claim 14, wherein the second set of instructions includes instructions to read the input signal on the input line to determine whether the internal memory domain is switched on and the first set of instructions includes a source address of the external memory domain and a destination address of the internal memory domain.

17. The computer system of claim 14, wherein the second set of instructions includes an instruction to determine an address for a next set of instructions based on reading the input signal on the input line.

18. The computer system of claim 14, wherein the power controller unit is to switch off all the internal memory domains of the computer system, leaving on none of the internal memory domains of the computer system.

19. The computer system of claim 14, wherein the power controller unit is to switch on and off the DMA controller.

20. The computer system of claim 14, wherein DMA controller is further coupled to the internal memory domain via a memory input line and a memory output line and the instructions including a third set of instructions to send an interrupt to the internal memory domain on the memory output line or wait for a status on the memory input line.
